(19) United States
(12) Patent Application Publication
(10) Pub. No.: US 2026/0065014 A1
(43) Pub. Date: Mar. 5, 2026

(54) CONFIDENTIALITY-PRESERVING SPLITTING OF A LARGE LANGUAGE MODEL

(71) Applicant: Cisco Technology, Inc., San Jose, CA (US)

(72) Inventors: Charles Fleming, Oxford, MS (US); Gaowen Liu, Naperville, IL (US); Jayanth Srinivasa, Newark, CA (US); Ramana Rao V.R. Kompella, Foster City, CA (US)

(73) Assignee: Cisco Technology, Inc., San Jose, CA (US)

(21) Appl. No.: 18/817,481

(22) Filed: Aug. 28, 2024

(51) Int. Cl. G06N 3/04

(52) U.S. Cl. CPC G06N 3/04

(57) ABSTRACT

In one implementation, a device in a local network receives, via a user interface, a prompt for input to a large language model that is external to the local network. The device sends the prompt to the large language model, wherein the large language model sends an intermediate embedding as a response to the prompt for input to one or more model layers split from the large language model that is hosted in the local network. The device receives an answer to the prompt from the one or more model layers hosted in the local network. The device provides the answer to the user interface for presentation to a user.

### TECHNICAL FIELD

The present disclosure relates generally to confidentiality-preserving splitting of a large language model.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform tasks by chaining multiple calls to one or more LLMs. For example, a first step can consist in formulating a plan in natural language, and subsequent steps in executing on this plan by writing code to call application programming interfaces (APIs) or libraries.

However, LLM providers typically host their LLMs and allow remote access to them via APIs. Many LLM providers also allow for the creation of specialized LLMs that are modified to have specific knowledge within a certain domain. To do so, a user or enterprise may upload any number of documents to the provider regarding that domain. For instance, one domain may be patent law, in which case the user or enterprise may upload any number of documents related to patent law, to form the specialized LLM.

One challenge with respect to specialized LLMs, though, is that the current approach requires uploading documents, which may include confidential information, to the LLM provider, which are then stored on its servers in conjunction with the specialized model. Storing the confidential information on a third-party host in this manner may be prohibited by law or contractual obligations. In addition, there is also the risk of the specialized model memorizing the confidential information, making it also possible for a malicious entity to trick the model to reveal the confidential information.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example of using a large language model (LLM) agent for network monitoring and troubleshooting;

FIG. 4 illustrates an example architecture for confidentiality-preserving splitting of an LLM; and

FIG. 5 illustrates an example simplified procedure for using a confidentiality-preserving splitting of a large language model.

### DESCRIPTION OF EXAMPLE IMPLEMENTATIONS

### Overview

According to one or more implementations of the disclosure, a device in a local network receives, via a user interface, a prompt for input to a large language model that is external to the local network. The device sends the prompt to the large language model, wherein the large language model sends an intermediate embedding as a response to the prompt for input to one or more model layers split from the large language model that is hosted in the local network. The device receives an answer to the prompt from the one or more model layers hosted in the local network. The device provides the answer to the user interface for presentation to a user.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

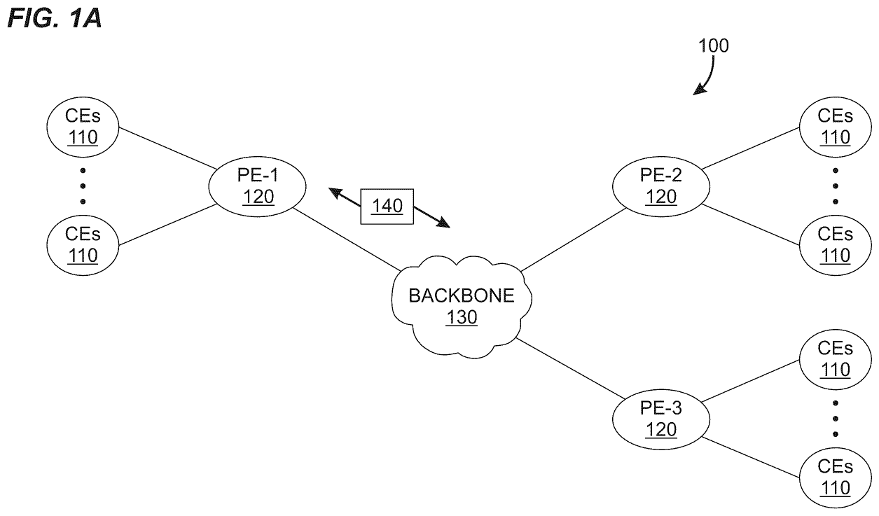

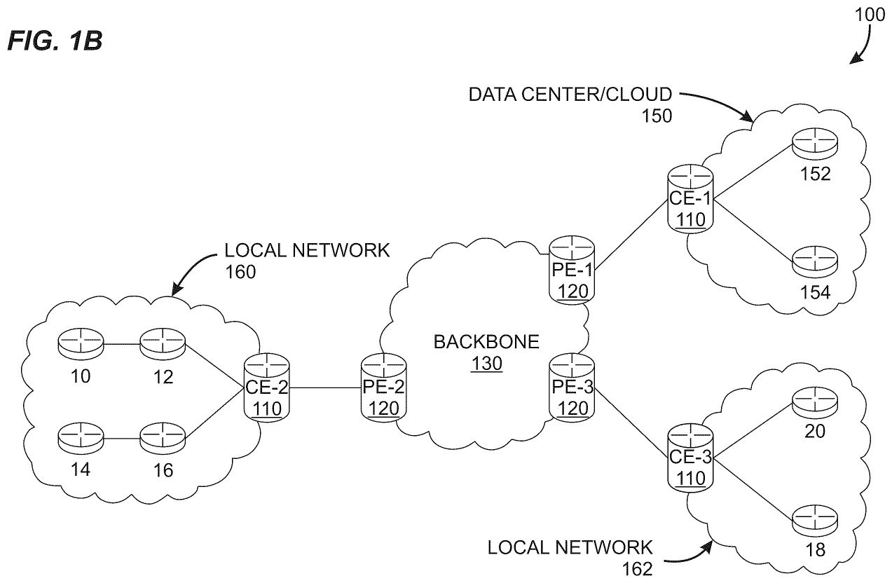

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection). 2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

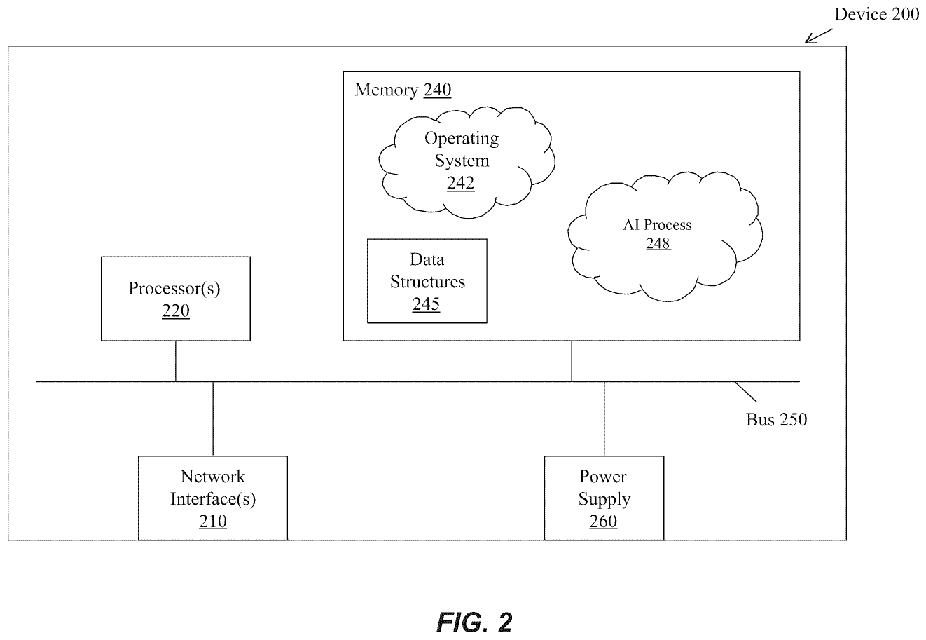

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250 and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise an artificial intelligence (AI) process such as AI process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor(s) 220, cause device 200 to perform the techniques described herein. To do so, in some implementations, AI process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ one or more supervised, unsupervised, or semi-supervised machine learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that AI process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

As noted above, the recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform tasks by chaining multiple calls to one or more LLMs. For example, a first step can consist in formulating a plan in natural language, and subsequent steps in executing on this plan by writing code to call application programming interfaces (APIs) or libraries.

However, LLM providers typically host their LLMs and allow remote access to them via APIs. Many LLM providers also allow for the creation of specialized LLMs that are modified to have specific knowledge within a certain domain. To do so, a user or enterprise may upload any number of documents to the provider regarding that domain. For instance, one domain may be patent law, in which case the user or enterprise may upload any number of documents related to patent law, to form the specialized LLM.

One challenge with respect to specialized LLMs, though, is that the current approach requires uploading documents, which may include confidential information, to the LLM provider, which are then stored on its servers in conjunction with the specialized model. Storing the confidential information on a third-party host in this manner may be prohibited by law or contractual obligations. In addition, there is also the risk of the specialized model memorizing the confidential information, making it also possible for a malicious entity to trick the model to reveal the confidential information.

### Confidentiality-Preserving Splitting of an LLM

The techniques introduced herein allow for the use of specialized LLMs while avoiding privacy concerns by splitting the LLM such that the layers trained using any confidential information are executed on-prem, thereby ensuring both the confidentiality of the training documents, as well as any confidential information that may be present in the answers generated by the split model.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various embodiments, a device in a local network receives, via a user interface, a prompt for input to a large language model that is external to the local network. The device sends the prompt to the large language model, wherein the large language model sends an intermediate embedding as a response to the prompt for input to one or more model layers split from the large language model that is hosted in the local network. The device receives an answer to the prompt from the one or more model layers hosted in the local network. The device provides the answer to the user interface for presentation to a user.

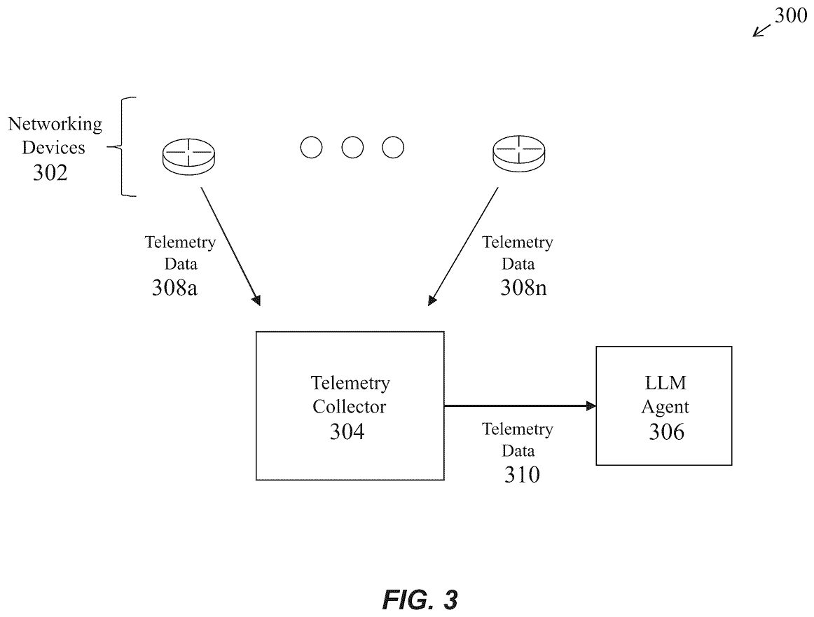

Operationally, FIG. 3 illustrates an example 300 of using a large language model (LLM) agent for network monitoring and troubleshooting, in various implementations.

As shown, one potential use for an LLM-based agent, such as agent 306, may be to perform tasks such as executing code, performing searches, writing code to make API calls or library calls, and the like. In the specific context of a computer network, this now allows for an agent, such as agent 306, to interface with a user for purposes such as any or all of the following:
Reporting the current and/or historical state of the network
Determining the root cause of issues in the network
Suggesting configuration changes to the network
Automatically implementing corrective measures
Etc.

For instance, assume that there is a plurality of networking devices 302, such as routers, switches, gateways, access points, or the like (e.g., a first through nth networking device). Networking device 302 may generate and send telemetry data 308a-308n to a telemetry collector 304, which may be hosted in the network or remote thereto. For instance, in the case of networking devices 302 comprising routers, telemetry data 308a-308n may comprise Netflow records, IPFIX records, or the like.

Telemetry collector 304 may then provide telemetry data 310 to agent 306 on a pull or push basis. In general, telemetry data 310 may take the form of information extracted from any of telemetry data 308a-308n, data aggregated from any of telemetry data 308a-308n, data derived from telemetry data 308a-308n, or the like.

For instance, consider the case in which a user interacts with agent 306 to evaluate the status of a particular router in networking devices 302. In such a case, agent 306 may obtain the relevant telemetry data 310 from telemetry collector 304 (or, alternatively, directly from the router), and formulate an answer for the user.

However, providing telemetry data 310 external to an enterprise network may present a security risk as telemetry data 310 may include information that should be kept secret (e.g., the location or addresses of devices in the network, what software they are running, etc.). Unfortunately, though, many LLMs are cloud-hosted, thereby requiring an agent such as agent 306 to provide the telemetry data 310 to the LLM provider for purposes of training/specialization, analysis, etc. This is also true with respect to any other information that an enterprise may consider to be confidential or otherwise protected. For instance, non-limiting examples of other types of information that an enterprise or other entity may deem to be confidential are as follows:
Personally-identifiable information (PII) such as social security numbers, names, etc.
Medical records
Human-resource records
Trade secrets
Proprietary information
Client lists or other customer information
Financial information
Research and Development (R&D) information
Etc.

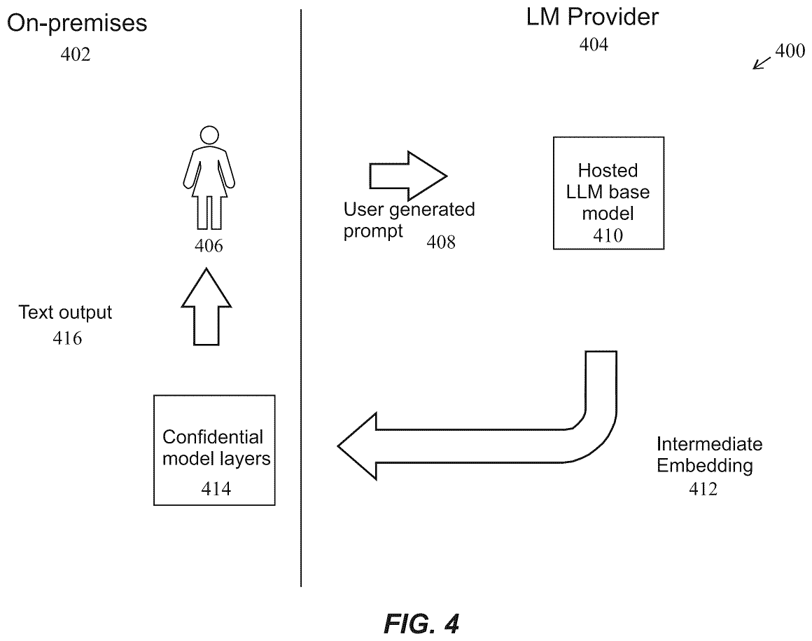

FIG. 4 illustrates an example architecture 400 for confidentiality-preserving splitting of an LLM, in various implementations. Rather than relying on a provider-hosted LLM, the techniques herein propose creating a split LLM, whereby the parts of the model that are proprietary to the LLM provider remain on the provider's servers, and the parts of the model specialized to the confidential information of an enterprise or other entity are executed on-premises.

More specifically, as shown, this can be achieved by starting with a base model that has been pretrained by the LLM provider. In turn, in various implementations, confidential information from the enterprise/entity are used to train any number of additional layers of that model, without updating the parameters of the base model. This can be achieved by performing training within the on-premises network 402 (e.g., that of the owner of the confidential information), by sending the confidential information to the LLM provider 404 (e.g., as part of a one-time upload that deletes the confidential information after training), or the like. In some instances, an administrator or other user may make a selection, via a user interface, of the confidential information on which the LLM is to be trained.

In various implementations, the system may then perform model splitting on the resultant LLM by removing the last few layers and potentially adding additional layers, to form two portions of the full LLM:
1. LLM base model 410—these layers comprise the pretrained base model; and
2. Confidential model layers 414—these are the layers trained using the confidential information.

Confidential model layers 414 are then deployed to a device located in on-premises network 402, which may be a networking device/entity located therein, and endpoint client, a server, or the like.

Inference using the split LLM may then proceed as follows:
1. A user 406 operates a user interface to issue a user-generated prompt 408 (e.g., via a chat interface, via an agent, etc.).
2. User-generated prompt 408 is then sent to LLM provider 404 for input to LLM base model 410. Typically, this means that user-generated prompt 408 is sent outside of on-premises network 402, such as via an API provided by LLM provider 404.
3. LLM base model 410 evaluates user-generated prompt 408 and generates an intermediate embedding 412.
4. LLM provider 404 then sends intermediate embedding 412 back to on-premises network 402 for input to confidential model layers 414.
5. Confidential model layers 414 then generates an output based on intermediate embedding 412, such as text output 416. Note that while the outputs of confidential model layers 414 typically comprise text, other forms of outputs may also be possible, such as one or more images, an audio file, multi-modal outputs, or the like, in further implementations.
6. The user interface of user 406 presents text output 416 (or any other output) from confidential model layers 414 for review.

Since confidential model layers 414 are executed within on-premises network 402, this helps to ensure that any confidential information included in text output 416 remain within on-premises network 402. In addition, as intermediate embedding 412 are output by LLM base model 410, whose layer parameters were not updated during the training of confidential model layers 414, it will also lack any confidential information.

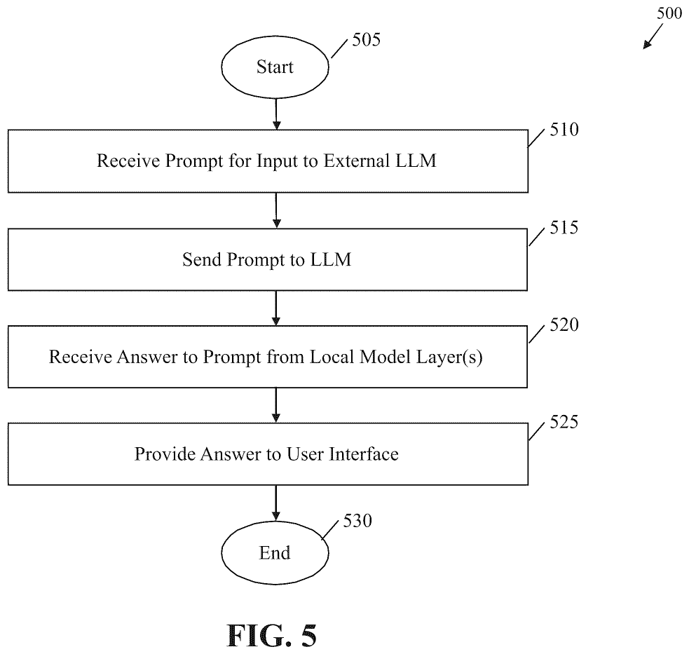

FIG. 5 illustrates an example simplified procedure 500 (e.g., a method) for using a confidentiality-preserving splitting of a large language model, in accordance with one or more implementations described herein. For example, a non-generic, specifically configured device (e.g., device 200), such as a router, firewall, controller for a network, endpoint, server, or the like, may perform procedure 500 by executing stored instructions (e.g., AI process 248). The procedure 500 may start at step 505, and continues to step 510, where, as described in greater detail above, the device may receive, via a user interface, a prompt for input to a large language model that is external to the local network. In some cases, the prompt comprises a query regarding a state of the local network. In further instances, the prompt comprises a query regarding information stored in one or more documents in the local network that have been deemed confidential.

At step 515, as detailed above, the device may send the prompt to the large language model, wherein the large language model sends an intermediate embedding as a response to the prompt for input to one or more model layers split from the large language model that is hosted in the local network. In some implementations, the one or more model layers hosted in the local network were trained using confidential information stored in the local network. In one implementation, the device may receive, via the user interface, a selection of the confidential information to be used to train the one or more model layers. In various implementations, the large language model comprises a plurality of pretrained layers whose parameters were not updated during training of the one or more model layers split from the large language model. In another implementation, the device sends the prompt to the large language model via an application programming interface (API).

At step 520, the device may receive an answer to the prompt from the one or more model layers hosted in the local network, as described in greater detail above. In some implementations, the device executes the one or more model layers. In further implementations, the device receives the answer from the one or more model layers from a second device in the local network. For instance, the second device may be a router, gateway, or switch.

At step 525, as detailed above, the device may provide the answer to the user interface for presentation to a user. In some instances, the answer comprises confidential information.

Procedure 500 then ends at step 530.

While there have been shown and described illustrative implementations that provide for confidentiality-preserving splitting of an LLM, it is to be understood that various other adaptations and modifications may be made within the spirit and scope of the implementations herein. For example, while certain implementations are described herein with respect to using certain models for purposes of making API calls, the techniques herein are not limited as such and can be used for purposes of managing the credentials associated with any task performed via a chatbot, such as executing a command line interface (CLI) command, logging into a remote system, or the like. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof.

Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
receiving, at a device in a local network and via a user interface, a prompt for input to a large language model that is external to the local network;
sending, by the device, the prompt to the large language model, wherein the large language model sends an intermediate embedding as a response to the prompt for input to one or more model layers split from the large language model that is hosted in the local network;
receiving, at the device, an answer to the prompt from the one or more model layers hosted in the local network; and
providing, by the device, the answer to the user interface for presentation to a user.

2. The method as in claim 1, wherein the device executes the one or more model layers.

3. The method as in claim 1, wherein the device receives the answer from the one or more model layers from a second device in the local network.

4. The method as in claim 3, wherein the second device comprises a router, gateway, or switch.

5. The method as in claim 1, wherein the one or more model layers hosted in the local network were trained using confidential information stored in the local network.

6. The method as in claim 5, further comprising:
receiving, via the user interface, a selection of the confidential information to be used to train the one or more model layers.

7. The method as in claim 1, wherein the answer comprises confidential information.

8. The method as in claim 1, wherein the large language model comprises a plurality of pretrained layers whose parameters were not updated during training of the one or more model layers split from the large language model.

9. The method as in claim 1, wherein the device sends the prompt to the large language model via an application programming interface (API).

10. The method as in claim 1, wherein the prompt comprises a query regarding a state of the local network.

11. An apparatus, comprising:
one or more network interfaces to communicate within a local network;
a processor coupled to the one or more network interfaces and configured to execute one or more processes; and
a memory configured to store a process that is executable by the processor, the process when executed configured to:
receive, via a user interface, a prompt for input to a large language model that is external to the local network;
send the prompt to the large language model, wherein the large language model sends an intermediate embedding as a response to the prompt for input to one or more model layers split from the large language model that is hosted in the local network;
receive an answer to the prompt from the one or more model layers hosted in the local network; and
provide the answer to the user interface for presentation to a user.

12. The apparatus as in claim 11, wherein the apparatus executes the one or more model layers.

13. The apparatus as in claim 11, wherein the apparatus receives the answer from the one or more model layers from a device in the local network.

14. The apparatus as in claim 13, wherein the apparatus comprises a router, gateway, or switch.

15. The apparatus as in claim 11, wherein the one or more model layers hosted in the local network were trained using confidential information stored in the local network.

16. The apparatus as in claim 15, wherein the process when executed is further configured to:
receive a selection of the confidential information to be used to train the one or more model layers.

17. The apparatus as in claim 11, wherein the answer comprises confidential information.

18. The apparatus as in claim 11, wherein the large language model comprises a plurality of pretrained layers whose parameters were not updated during training of the one or more model layers split from the large language model.

19. The apparatus as in claim 11, wherein the apparatus sends the prompt to the large language model via an application programming interface (API).

20. A tangible, non-transitory, computer-readable medium storing program instructions that cause a device to execute a process comprising:
receiving, at a device in a local network and via a user interface, a prompt for input to a large language model that is external to the local network;
sending, by the device, the prompt to the large language model, wherein the large language model sends an intermediate embedding as a response to the prompt for input to one or more model layers split from the large language model that is hosted in the local network;
receiving, at the device, an answer to the prompt from the one or more model layers hosted in the local network; and
providing, by the device, the answer to the user interface for presentation to a user.
